(19) United States
(12) Patent Application Publication
(10) Pub. No.: US 2015/0214693 A1
(43) Pub. Date: Jul. 30, 2015

(54) APPARATUS AND METHOD FOR STABILIZING PULSE LASER OUTPUT

(71) Applicant: Korea Research Institute of Standards and Science, Daejeon (KR)

(72) Inventors: Kee-Suk HONG, Daejeon (KR); Dong-Hoon Lee, Daejeon (KR); Seongchong Park, Daejeon (KR); Seung-Nam Park, Daejeon (KR); Seung-Kwan Kim, Daejeon (KR)

(21) Appl. No.: 14/674,306

(22) Filed: Mar. 31, 2015

Related U.S. Application Data
(63) Continuation of application No. PCT/KR2013/008661, filed on Sep. 27, 2013.

(30) Foreign Application Priority Data
Oct. 4, 2012 (KR) 10-2012-0110099

(51) Int. Cl. H01S 3/13; G02F 1/125; H01S 3/00

(52) U.S. Cl. CPC H01S 3/1305; H01S 3/0085; G02F 1/125

(57) ABSTRACT

A pulse laser output stabilizing apparatus including a directional coupler to receive output of pulse laser, the output branching into a first optical path and a second optical path, a photodetector to receive light branching into the first optical path and output current according to intensity of the light, a current-voltage converter to convert output current of the photodetector into a voltage and output converted voltage, a function generator to provide an output proportional to output signal of the current-voltage converter with a predetermined frequency, a time delay unit on the second optical path providing a predetermined time delay for feedback control, and an acousto-optic tunable modulator to receive output signal of the functional generator and optical signal from the time delay unit as an input and modulate and output the optical signal from the time delay unit according to amplitude of the output signal of the function generator.

### CROSS-REFERENCE TO RELATED APPLICATIONS

This application is a continuation of and claims priority to PCT/KR2013/008661 filed on Sep. 27, 2013, which claims priority to Korea Patent Application No. 10-2012-0110099 filed on Oct. 4, 2010, the entireties of both of which are hereby incorporated by reference herein.

### TECHNICAL FIELD

The present disclosure generally relates to pulse laser output stabilizing apparatuses and, more particularly, to a pulse laser output stabilizing apparatus using real-time feedback control and an acousto-optic tunable modulator.

### BACKGROUND

Since 2000s, optical sources have been developed vigorously. Besides industry of lasers, various other components such as a light-emitting diode (LED) and a semiconductor optical amplifier (SOA) have also been grown rapidly and have been used in various industrial applications such as lightings, tests, and skin treatments. In laser fields of bandwidth, ultra-broadband light source components of 250 nm to 2500 nm (Optical Parametric Oscillator, Super-continuum source, etc.) are also well developed using nonlinear effect. These broadband light sources have extended their application range using new bands of wavelength in optical communication, optical measurement, and bio-imaging fields.

However, in case of a broadband laser, time-dependent output power variation is very large. Since conventional low power lasers (<1 W) used in industries are continuous-wave (CW) type lasers, they are very stable lasers whose time-dependent output variation is less than 5 percent. Meanwhile, since broadband lasers are pulse-type lasers and use nonlinear crystal, their time-dependent output variation is very large.

### SUMMARY

Embodiments of the present disclosure provide a pulse laser output stabilizing apparatus for stabilizing a broadband pulse laser output.

A pulse laser output stabilizing apparatus according to an embodiment of the present disclosure may include a directional coupler configured to receive an output of pulse laser such that the output branches into a first optical path and a second optical path; a photodetector configured to receive light branching into the first optical path and output current according to the intensity of the light; a current-voltage converter configured to convert output current of the photodetector into a voltage and output the converted voltage; a function generator configured to provide an output proportional to an output signal of the current-voltage converter with a predetermined frequency; a time delay unit disposed on the second optical path to provide a predetermined time delay for feedback control; and an acousto-optic tunable modulator configured to receive an output signal of the functional generator and an optical signal provided from the time delay unit as an input and modulate and output the optical signal provided from the time delay unit according to the amplitude of the output signal of the function generator.

In example embodiments, the pulse laser output stabilizing apparatus may further include an amplifier disposed between the current-voltage converter and the function generator to amplify an output signal of the current-voltage converter and provide the amplified output signal as an input signal of the function generator.

In example embodiments, the acousto-optic tunable modulator may include a disc-shaped piezoelectric transducer having a first through-hole formed in its center, the piezoelectric transducer being configured to generate an acoustic wave; a conic dielectric cone having a second through-hole formed in its center; an optical fiber inserted into the first through-hole and the second through-hole to be disposed there; and an acoustic damper spaced apart from the dielectric cone by a predetermined distance to be coupled with the optical fiber.

In example embodiments, a wavelength of the pulse laser may be variable.

In example embodiments, delay time of the time delay unit may be between 50 and 70 microseconds.

A pulse laser output stabilizing method according to an embodiment of the inventive concept may include receiving output light of a pulse laser to branch into a first optical path and a second optical path; receiving light branching into the first optical path to output first current depending on light intensity; converting the first current into a first voltage; providing an output of a second voltage proportional to the first voltage with a predetermined frequency; providing a predetermined time-delay on the second optical path; receiving the second voltage to acousto-optically modulate and output a time-delayed optical signal of the second optical path according to the magnitude of the second voltage.

In example embodiments, the pulse laser output stabilizing method may further include amplifying the first voltage.

In example embodiments, a wavelength of the pulse laser may be variable.

In example embodiments, the delay time may be between 50 and 70 microseconds.

### BRIEF DESCRIPTION OF THE DRAWINGS

The present disclosure will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the present disclosure.

FIG. 1 illustrates an optical fiber acousto-optic tunable modulator.

FIG. 2 is a block diagram of a pulse laser output stabilizing apparatus according to an embodiment of the present disclosure.

FIG. 3A is a test schematic diagram of measuring transmission control characteristics of an acousto-optic tunable modulator (AOTM).

FIGS. 3B and 3C illustrate modulation performances of an acousto-optic tunable modulator (AOTM) depending on frequencies, respectively.

FIGS. 4A and 4B illustrate modulation performances of an acousto-optic tunable modulator (AOTM) depending on voltages, respectively.

FIGS. 5A and 5B illustrate operation delay times of an acousto-optic tunable modulator (AOTM) depending on voltages, respectively.

### DETAILED DESCRIPTION

Lasers operating in the wavelength range from 250 nm to 2500 nm such as an optical parametric oscillator (OPO) and a super-continuum source (SC) have been developed to meet a need for broadband lasers. However, due to pulse-type and nonlinear characteristics, outputs of these lasers are much more unstable than an output of continuous wave (CW) laser. Accordingly, an apparatus for stabilizing an output of broadband laser in real time is required.

The present disclosure provides an apparatus for stabilizing an output of pulse laser in real time which may operate with a broad wavelength range of 250 nm to 2500 nm.

First, the description will be given to the operation principle of an acousto-optic wavelength tunable modulator that is an essential component of a pulse laser output stabilizing apparatus according to the present disclosure.

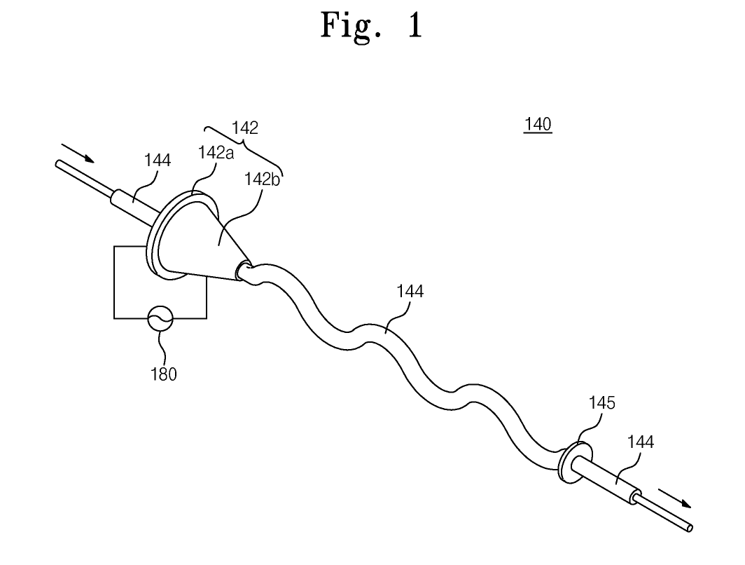

FIG. 1 illustrates an optical fiber acousto-optic tunable modulator.

Referring to FIG. 1, an optical fiber acousto-optic tunable modulator (AOTM) 140 includes an optical fiber 144, an acoustic generation part 142 to apply an acoustic wave, and an acoustic damper 145 to absorb acoustic energy when fine bending is produced by the generated acoustic wave.

The acoustic generation part 142 may include a disc-shaped piezoelectric transducer 142a and a dielectric cone 142b. The piezoelectric transducer 142a may be a shear mode lead zirconate titanate (PZT) piezoelectric transducer. The piezoelectric transducer 142a and the dielectric cone 142b are bonded to each other. A first through-hole is formed in the center of the piezoelectric transducer 142a, and a second through-hole is formed on a central axis of the dielectric cone 142b. The optical fiber 144 is inserted into the first through-hole and the second through-hole.

Light of an LP01 mode of a Gaussian shape, which is irradiated from laser, may travel along the optical fiber 144. In this case, when a function generator 180 applies a sine-type voltage signal of a predetermined oscillation frequency to the piezoelectric transducer 142, the piezoelectric transducer 142a may generate an acoustic wave in a vertical direction according to the oscillation frequency. Accordingly, the dielectric cone 142b bonded to the piezoelectric transducer 142a concentrate the acoustic energy on a vertex of the dielectric cone 142b. Thus, the acoustic energy produces periodical bending at the optical fiber 144. When a period of the periodical bending satisfies a phase matching condition, the LP01 mode may be maximally converted into an LP1m mode. The phase matching condition corresponds to a case where the acoustic wavelength (A) is equal to effective refractive indices of the LP01 mode and the LP1m mode.

That is, β₀₁-β₁₁=2π/Λ,

Where, β₀₁ represents a propagation constant of the LP01 mode and β₁₁ represents a propagation constant of the LP11 mode.

The acoustic damper 145 is disposed to be sufficiently spaced apart from the dielectric cone 142b along the optical fiber 144. The acoustic damper 145 may absorb the acoustic energy that travels along the optical fiber 144.

The converted LP1m mode may be removed through a mode stripper (not shown) that is a higher mode stripper. Thus, a transmission of the LP01 mode provided to the AOTM 140 from the laser may be adjusted. That is, the AOTM 140 may perform intensity modulation.

The AOTM 140 may modulate a transmission of an input terminal by a frequency (f) to adjust the periodical bending provided to the function generator 180 and a voltage (V) to adjust amplitude of the bending.

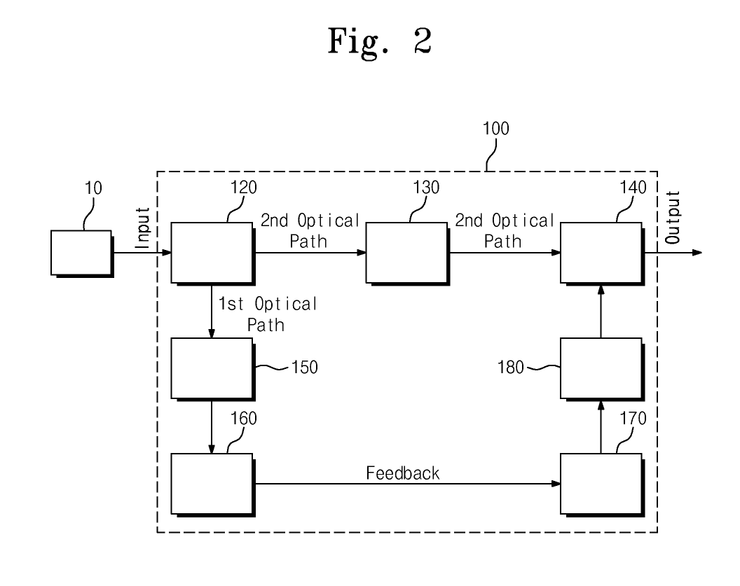

FIG. 2 is a block diagram of a pulse laser output stabilizing apparatus according to an embodiment of the present disclosure.

Referring to FIG. 2, the pulse laser output stabilizing apparatus includes a directional coupler 120 configured to receive an output of pulse laser 10 such that the output branches into a first optical path and a second optical path, a photodetector 150 configured to receive light branching into the first optical path and output current according to the intensity of the light, a current-voltage converter 160 configured to convert output current of the photodetector 150 into a voltage and output the converted voltage, a function generator 180 configured to provide an output proportional to an output signal of the current-voltage converter 160 with a predetermined frequency, a time delay unit 130 disposed on the second optical path to provide a predetermined time delay for feedback control, and an acousto-optic tunable modulator 140 configured to receive an output signal of the functional generator 180 and an optical signal provided from the time delay unit 130 as an input and modulate and output the optical signal provided from the time delay unit 130 according to the amplitude of the output signal of the function generator 180.

Laser output stabilizing apparatuses capable of providing feedback in real time may be classified into an optics module and an electronics module. The electronics module performs a feedback function to generate a stabilized pulse.

The pulse laser 10 outputs pulse light, and the intensity of the pulse light becomes unstable depending on time. The pulse laser 10 may be an optical parametric oscillator (OPO) or a super-continuum source (SC). A wavelength of the pulse laser 10 is variable. The frequency of the pulse laser 10 may vary in the entire or partial area within the range from 250 nm to 2500 nm.

The pulse light is provided to the directional coupler 120. The directional coupler 120 divides an optical path into the first optical path and the second optical path. More specifically, the output light of the pulse laser may branch into two optical paths via an optical fiber directional coupler.

First light propagating along the first optical path is provided to the photodetector 150 to provide a control signal to the AOTM 140. Second light propagating along the second optical path is modulated by the AOTM 140. The time delay unit 130 is disposed between the AOTM 140 and the directional coupler 120 to compensate a time delay for modulating the second light provided to the AOTM 140. The time delay unit 130 may be an optical fiber. The time delay provided by the time delay unit 130 may be between several microseconds (μsec) and tens of μsec.

The first light is provided to the photodetector 150. The photodetector 150 may be a photodiode capable of adjusting temperature. The photodector 150 may convert the intensity of the first light into current. An output signal of the photodetector 150 may be converted into a voltage signal through the current-voltage converter 160.

Since the magnitude of an output signal of the current-voltage converter 160 is small, the output signal of the current-voltage converter 160 may be provided to an amplifier 170. The amplifier 170 may amplify and output an input voltage signal. A gain of the amplifier 170 is variable.

An output signal of the amplifier 170 is provided to the function generator 180. An output signal of the function generator 180 may have a predetermined frequency and be in proportion to an input signal. In case of an input terminal of a laser pulse with a wavelength range of 1500 nm, the frequency may be 2.23 MHz to 2.27 MHz.

An output signal of the function generator 180 is provided to the AOTM 140. The AOTM 140 vibrates an optical fiber with the frequency of the function generator 180 and an output voltage of the amplifier 170 to adjust a transmission.

For example, when the pulse laser 10 outputs a high-power pulse, the time delay unit 130 delays time and an amplified voltage detected by the photodetector 150 is combined with the function generator 180 to provide a control signal the AOTM 140 such that the transmission is reduced to allow only the fixed amount of light to be transmitted for the delayed time. On the other hand, when the pulse laser 10 outputs a low-output pulse, a specific frequency of a low voltage is controlled by the function generator 180 to allow the AOTM 140 to increase the transmission. Thus, the AOTM 140 outputs a constant output pulse light bundle.

The most important point to manufacture a laser output stabilizing apparatus capable of providing feedback in real time is to minimize feedback time. For achieving this, performance evaluation of the AOTM 140 is required.

If the current-voltage converter 160, the amplifier 170 or the function generator 180 is a programmed device, time required to execute a command is about several milliseconds (ms). Accordingly, the time delay unit 130 needs an optical fiber having a length of hundreds of kilometers (km) for time delay. For example, if time delay of 1 ms occurs, a length of an optical fiber is about 200 km when a refractive index of the optical fiber is 1.45. Loss of a typical optical fiber is about 0.22 dB/km at a wavelength of 1550 nm. Therefore, when light travels a distance of 200 km, 44 dB is lost and thus the light reaching the AOTM 140 is substantially entirely lost.

Accordingly, all steps for real-time feedback may be preferably performed by a passive apparatus having no program command. In this case, the time taken by the current-voltage converter 160, the amplifier 170 or the function generator 180 is about 1 μsec. Meanwhile, it is necessary to measure operation time of the AOTM 140 depending on a frequency and a voltage.

First, frequency-dependent operation time of the AOTM 140 was investigated. The operation principle of the AOTM 140 serves to remove the LP01 mode, which is an output mode of an input terminal at laser, through modulation caused by periodical bending that is produced by applying an acoustic wave to an optical fiber. The periodical bending may vary depending on a frequency applied from the function generator 180.

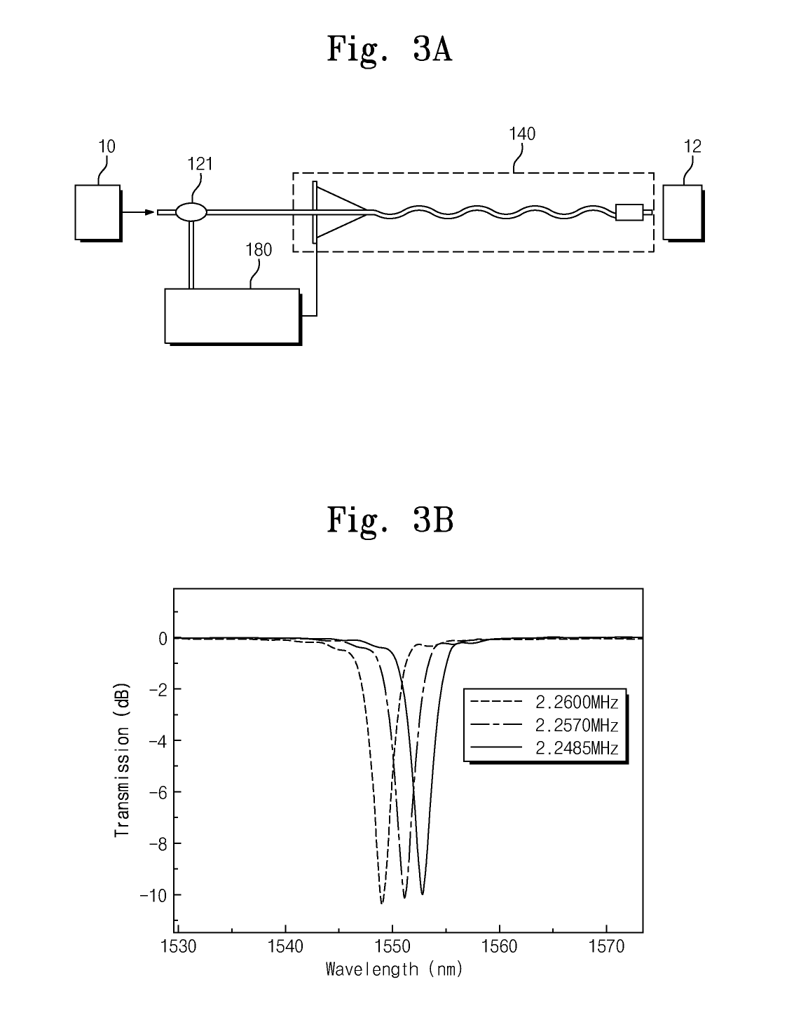

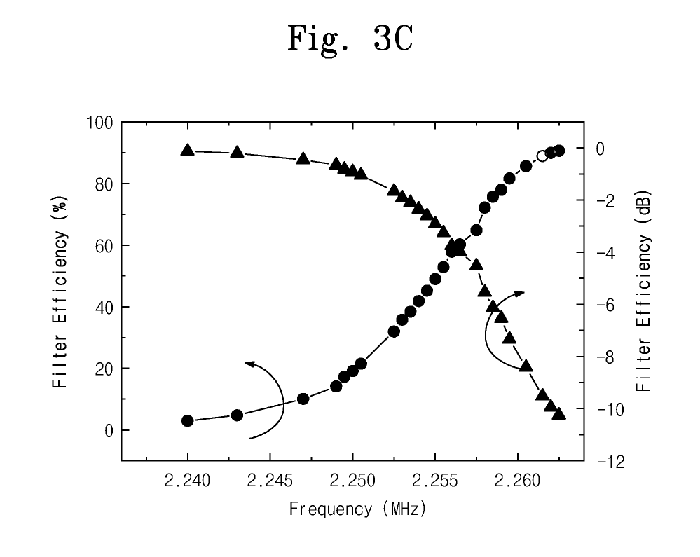

FIG. 3A is a test schematic diagram of measuring transmission control characteristics of an acousto-optic tunable modulator (AOTM).

FIGS. 3B and 3C illustrate modulation performances of an acousto-optic tunable modulator (AOTM) depending on frequencies, respectively.

Referring to FIG. 3A, a pulse laser 10 used an amplified spontaneous emission (ASE) light source that oscillates to a broadband of 1530 nm to 16000 nm to view a broad spectrum. An optical spectrum analyzer 12 was used to measure transmission control characteristics depending on wavelength band. A directional coupler makes an optical path branch into two. One of the two branching optical paths is provided to an AOTM 140, and the other is provided to a function generator 180.

Referring to FIG. 3B, when the function generator 180 applies different frequencies to the AOTM 140, a modulation occurs at different central wavelengths according to the frequencies. At this point, an applied voltage was fixed to 5.6 Vpp. When 2.2600 MHz was applied, light of −10 dB (about 92 percent) was filtered and blocked out at a central wavelength of 1549 nm. When 2.2570 MHz is applied, light is filtered at a central wavelength of 1551 nm. When 2.485 MHz is applied, light is filtered at a central wavelength of 1554 nm. That is, if a voltage of 5.6 Vpp and a frequency of 2.260 MHz are applied when laser of 1550 nm is used, the AOTM 140 may block out 92 percent of light and transmit 8 percent of the light.

Referring to FIG. 3C, when laser of 1550 nm that is a single wavelength is used, the transmission of the AOTM 140 varies depending on frequency variation. In FIG. 3C, circles represent a transmission of percent unit and triangles represent transmission of decibel (dB) unit. Since filter efficiency is nearly close to 1 percent when a frequency of 2.240 MHz is applied, 99 percent of light is transmitted. However, when a frequency of 2.260 MHz is applied, 90 percent or more of light is filtered and 10 percent or less of the light is transmitted. Thus, the AOTM 140 may modulate its input optical signal by fixing an applied voltage and changing a frequency.

The AOTM 140 may perform modulation only by changing a frequency. However, a current-frequency converter or a voltage-frequency converter is required to provide feedback in real time. However, most of the above devices require a field programmable gate array (FPGA) that an active device where a program need to be executed. The number of FPGAs to change a frequency is limited according to a channel, and command execution time increases in units of several milliseconds (ms) when a program command is input to an FPGA. Therefore, an FPGA is not suitable for modulation.

Accordingly, voltage-dependent modulation of an AOTM is required to decrease command execution time or feedback time.

Although a test device has the same configuration as shown in FIG. 3A, a frequency was fixed to 2.2625 MHz. Modulation performance of an AOTM was investigated with the change of a voltage applied to the AOTM.

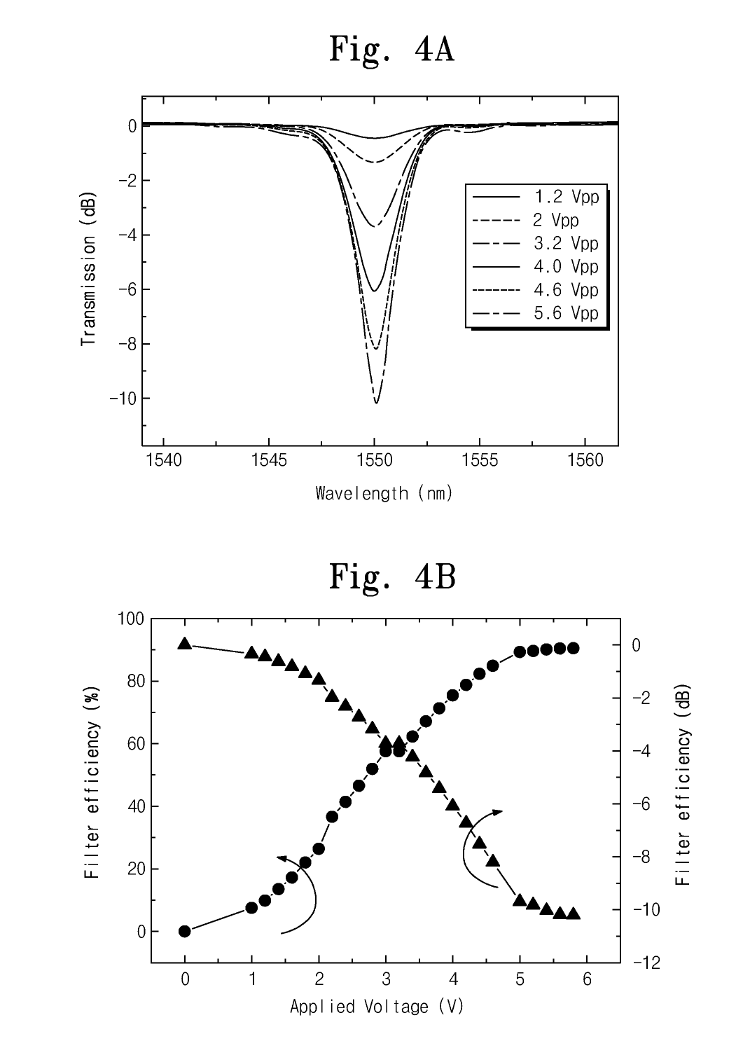

FIGS. 4A and 4B illustrate modulation performances of an acousto-optic tunable modulator (AOTM) depending on voltages, respectively.

Referring to FIGS. 4A and 4B, the modulation effect of the AOTM 140 is displayed when a voltage of 1.2 Vpp to 5.6 Vpp is applied. When a voltage of 1.2 Vpp was applied, 90 percent of light was transmitted. However, when a voltage of 5.6 Vpp was applied, 8 percent of light was transmitted. The transmission increases in proportion to an applied voltage. In particular, when a voltage of 2 Vpp to 4 Vpp is applied, the transmission is almost linearly proportional to the applied voltage. Thus, output stabilization may be provided using this area.

Output light of the pulse laser 10 is converted into current in the photodetector 150, and the current of the photodetector 150 is converted into a voltage signal by the current-voltage converter 160. If a voltage applied to the AOTM 140 increases when the intensity of the output light of the pulse laser 10 is high, the AOTM 140 outputs an input signal after significantly reducing the input signal. If a voltage applied to the AOTM 140 decreases when the intensity of the output light of the pulse laser 10 is low, the AOTM 140 outputs an input signal after transmitting the most of the small input signal. Thus, an output of the AOTM 140 may be constantly maintained although the output intensity of the pulse laser 10 becomes unstable with time.

Operation delay time of the AOTM 140 was measured. The operation delay time of the AOTM 140 is preferably less than tens of microseconds (μsec) to implement an active output stabilizing apparatus that is capable of providing feedback in real time. If the time taken for providing feedback to operate the AOTM 140 is too long, energy loss of an optical fiber serving as time delay is seriously great. Therefore, it is necessary to measure the operation delay time of the AOTM 140.

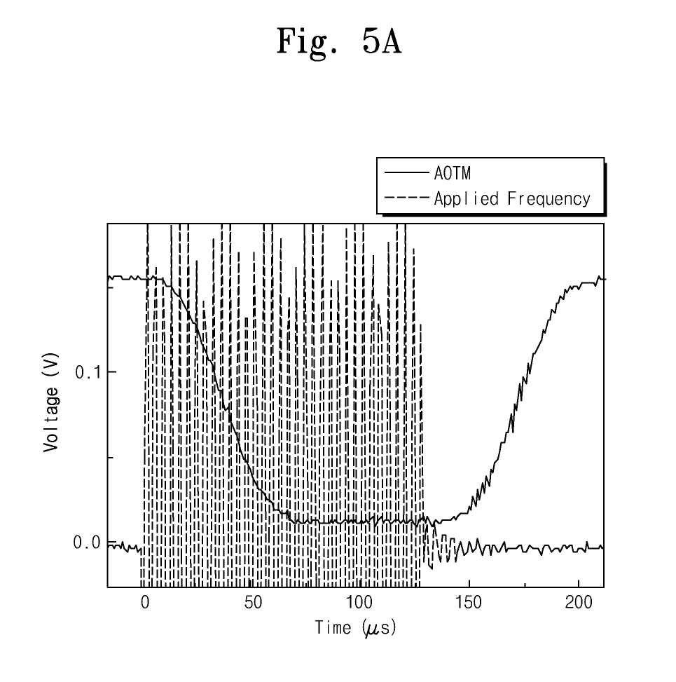

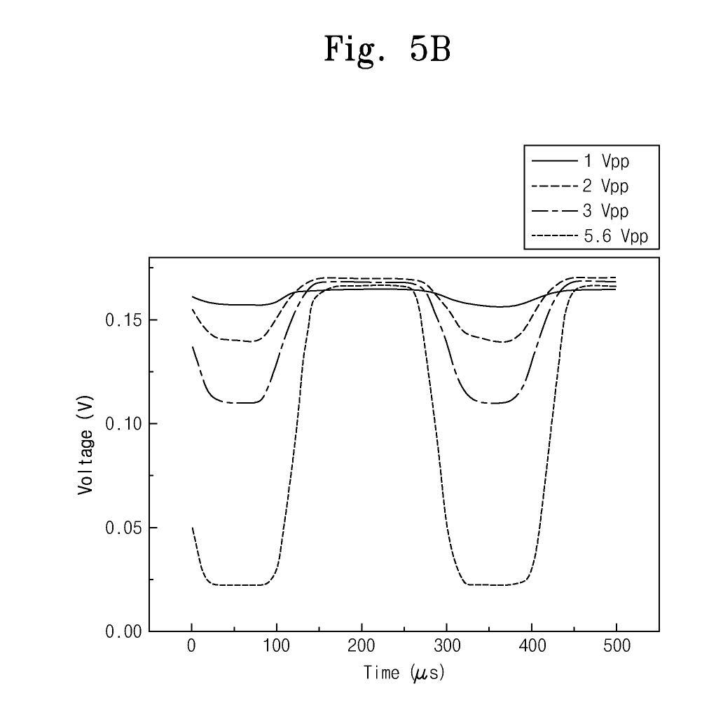

FIGS. 5A and 5B illustrate operation delay times of an acousto-optic tunable modulator (AOTM) depending on voltages, respectively.

Referring to FIGS. 5A and 5B, a laser light source employed a tunable laser diode (Tunable LD) with central wavelength of 1550.4 nm to measure the operation delay time of the AOTM 140. In addition, the function generator 180 used a frequency of 2.2625 MHz which is capable of maximally filtering a light source. An output voltage of the function generator 180 was 5.6 Vpp and was switched on/off with a period of 150 microseconds (μsec). An output of the function generator 180 may periodically switch on/off the AOTM 140. Thus, the light intensity measured by a fast photodetector (whose rising/falling time is about 300 picoseconds (psec)) disposed at an output terminal of the AOTM 140 varies depending time. The photodector is a photodiode whose rising/failing time is about 300 psec.

The function generator 180 applies a voltage to the AOTM 140, and rising time in which the AOTM 140 operates normally is about 60 μsec. In addition, when the AOTM 140 stops operating, falling time is about 60 μsec.

If the time taken before the AOTM 140 during a feedback procedure is expected to be 1 μsec, the total feedback time is about 61 μsec. The delay time of 61 μsec corresponds to optical fiber length of 12 kilometers (km). The optical fiber has a loss of 0.22 dB/km at 1550 nm. Accordingly, an output of the optical fiber is 25 percent lost. As a result, the delay time of 61 μsec may be applied to an output stabilizing apparatus which is capable of providing feedback in real time.

The AOTM 140 is an active system modulated by an applied voltage.

However, it was confirmed that delay time did not vary depending the magnitude of an applied voltage.

The operation delay time or rising time of the AOTM 140 depending on an applied voltage is shown. When voltages of 1 to 5.6 Vpp are applied to the AOTM 140, modulation values are different from each other but the AOTM 140 has the same operation delay time of 60 μsec.

As described above, a pulse laser output stabilizing apparatus according to an embodiment of the present disclosure may provide stabilized output characteristics using an acousto-optic tunable modulator and real-time feedback control.

Although the present disclosure has been described in connection with the embodiment of the present disclosure illustrated in the accompanying drawings, it is not limited thereto. It will be apparent to those skilled in the art that various substitutions, modifications and changes may be made without departing from the scope and spirit of the present disclosure.

1. A pulse laser output stabilizing apparatus comprising:
a directional coupler configured to receive an output of pulse laser such that the output branches into a first optical path and a second optical path;
a photodetector configured to receive light branching into the first optical path and output current according to the intensity of the light;
a current-voltage converter configured to convert output current of the photodetector into a voltage and output the converted voltage;
a function generator configured to provide an output proportional to an output signal of the current-voltage converter with a predetermined frequency;
a time delay unit disposed on the second optical path to provide a predetermined time delay for feedback control; and
an acousto-optic tunable modulator configured to receive an output signal of the functional generator and an optical signal provided from the time delay unit as an input and modulate and output the optical signal provided from the time delay unit according to the amplitude of the output signal of the function generator.

2. The pulse laser output stabilizing apparatus of claim 1, further comprising:
an amplifier disposed between the current-voltage converter and the function generator to amplify an output signal of the current-voltage converter and provide the amplified output signal as an input signal of the function generator.

3. The pulse laser output stabilizing apparatus of claim 1, wherein the acousto-optic tunable modulator comprises:
a disc-shaped piezoelectric transducer having a first through-hole formed in its center, the piezoelectric transducer being configured to generate an acoustic wave;
a conic dielectric cone having a second through-hole formed in its center;
an optical fiber inserted into the first through-hole and the second through-hole to be disposed there; and
an acoustic damper spaced apart from the dielectric cone by a predetermined distance to be coupled with the optical fiber.

4. The pulse laser output stabilizing apparatus of claim 1, wherein a wavelength of the pulse laser is variable.

5. The pulse laser output stabilizing apparatus of claim 1, wherein delay time of the time delay unit is between 50 and 70 microseconds.

6. A pulse laser output stabilizing method comprising:
receiving output light of a pulse laser to branch into a first optical path and a second optical path;
receiving light branching into the first optical path to output first current depending on light intensity;
converting the first current into a first voltage;
providing an output of a second voltage proportional to the first voltage with a predetermined frequency;
providing an predetermined time-delay on the second optical path;
receiving the second voltage to acousto-optically modulate and output an time-delayed optical signal of the second optical path according to the magnitude of the second voltage.

7. The pulse laser output stabilizing method of claim 6, further comprising:
amplifying the first voltage.

8. The pulse laser output stabilizing method of claim 6, wherein a wavelength of the pulse laser is variable.

9. The pulse laser output stabilizing method of claim 6, wherein the delay time is between 50 and 70 microseconds.
